(19) United States
(12) Patent Application Publication
(10) Pub. No.: US 2020/0327254 A1
(43) Pub. Date: Oct. 15, 2020

(54) SYSTEM AND METHOD TO FIND ORIGIN AND TO PREVENT SPREAD OF FALSE INFORMATION ON AN INFORMATION SHARING SYSTEMS

(71) Applicant: TruthShare Software Private Limited, Bangalore (IN)

(72) Inventors: Deepika Abilash, Bangalore (IN); Abilash Soundararajan, Bangalore (IN)

(73) Assignee: TruthShare Software Private Limited

(21) Appl. No.: 16/839,280

(22) Filed: Apr. 3, 2020

(30) Foreign Application Priority Data
Apr. 10, 2019 (IN) 201941014533
Jan. 22, 2020 (IB) PCT/IB2020/050464

(51) Int. Cl. G06F 21/62; G06F 16/23; H04L 9/32

(52) U.S. Cl. CPC G06F 21/6263; H04L 9/3239; G06F 16/2379

(57) ABSTRACT

A system and method 100 to find origin and to prevent spread of false information across information sharing platforms is disclosed. The present system 100 provides a balanced technical solution achieving—privacy, law enforcement and information sharing in social media platforms for all participants. Pseudo Identity of user and hash of every unique message across participating social media platforms is mapped and stored securely, which by itself cannot result in identification of users or shared information. However, when false information is reported and verified, a Zero Knowledge Proof based mechanism can be triggered which can help in blacklisting verified fake news and identifying its first origin across social media platforms. The solution architects a novel Zero Knowledge Proof framework to achieve objectives compliant with privacy regulations, incentivizing truthful validation of reported false information, in an auditable data storage, protecting innocent user privacy and identifying false information originators.

### CROSS-REFERENCE TO RELATED APPLICATION

This application claims priority from a patent application filed in India bearing application no. 201941014533, filed on Apr. 10, 2019 and titled “SYSTEM FOR FINDING ORIGIN AND PREVENTING SPREAD OF FAKE INFORMATION IN AN INFORMATION SHARING PLATFORM”.

### FIELD OF INVENTION

Embodiments of a present disclosure relate to a false information, and more particularly to a system to find origin and to prevent spread of false information across information sharing platforms, while being data privacy compliant.

### BACKGROUND

Information sharing systems such as messaging platforms and social media platforms are interactive computer-mediated technologies that facilitate the creation and sharing of information, ideas, career interests and other forms of expression through virtual communities and networks. Information sharing platforms have influenced information gathering. Every minute, people around the world are posting pictures, videos, tweeting and otherwise communicating about all sorts of events and happenings. However, lot of the information shared on the social media are false. False information in the social media constitute a potential threat to public.

At present, social media platforms have two options which is either anonymity or complete exposure of user identity and information. Because of the limited options, the social media platforms either end up giving privacy to people with malicious intent such as terrorist or end up exposing messages and identity of genuine users which are bad.

One such scenario can be spreading false information about national integrity, security, hatred, violence, child abuse, business, religion, political parties to influence public. Also, a plurality of users is spreading the same false information by sharing the false information to other users via information sharing platform. In a similar manner, the plurality of scenarios makes it difficult to identify the falseness of information. Although various fact checking websites are available online, but these websites provides a fact check response in a slow manner. Also, the fact checking websites do not help in identifying the origin and preventing spread of false information in an information sharing platform.

Conventionally, the system which is available for tracking and preventing spread of information in the information sharing platform, tracks the information by extracting information from information sharing platform by using bottom up approach. In the bottom up approach, users extract the information by searching keywords and maintain database for them. However, bottom up approach requires guess work and constant maintenance of lists and keywords. Also, such system does not provide any security mechanism for the privacy of customers. Moreover, such system creates redundancy while maintaining the database which affects the integrity of the database. The aforementioned issues make the above system less reliable and less efficient.

Hence, there is a need for an improved system to find origin and to prevent spread of false information on an information sharing system.

### BRIEF DESCRIPTION

In accordance with an embodiment of the disclosure, a system to find origin and to prevent spread of false information on a system is disclosed. The system includes a user identity mapping subsystem configured to maintain a personally identifiable information and a pseudonymous identity associated with one or more registered users upon registration by the one or more users on the information sharing system. The system also includes a pseudonymous identity and shared information subsystem operatively coupled to the user identity mapping subsystem. The pseudonymous identity and shared information subsystem are configured to capture the pseudonymous identity of an originator of information. The pseudonymous identity and shared information subsystem are also configured to capture the pseudonymous identity of each information upon sharing the information on at least one information sharing system. The system also includes a falsehood reporting subsystem configured to record reported false information without knowing information about the pseudonymous identity of the originator of information. The system also includes a fact checker subsystem operatively coupled to the falsehood reporting subsystem. The fact checker subsystem is configured to verify claim associated with a reported false information without the knowledge of originator or reporter upon receiving confirmation about the message shared on at least one information sharing platform. The system also includes a false information blacklist subsystem operatively coupled to the fact checker subsystem. The false information blacklist subsystem is configured to store verified false information of at least one information sharing systems, upon confirmation of sharing of the false information on at least one of the information sharing system and confirmation of the falsehood by fact checkers, without knowledge of the originator or reporter of information. The system also includes a false information spread prevention subsystem operatively coupled to the false information blacklist subsystem. The false information spread prevention subsystem is configured to enable the information sharing system to take actions such as prevent forwarding, flagging or deleting information against the end users involved in the false information blocklist like based on business requirement without any knowledge of originator of information, reporter, verifier and holder of the false information. The system also includes an origin identification subsystem operatively coupled to the false information spread prevention subsystem. The origin identification subsystem is configured to enable an entity to request for pseudonymous identity of the originator of the information from the maintainer of pseudonymous identity and shared information mapping subsystem upon digital confirmation of information sharing on the information sharing system, reporting and verification of the information. The origin identification subsystem is also configured to enable the entity to further request for the personally identifiable information of the acquired pseudonymous identity of the originator.

In accordance with another embodiment, a method for finding origin and preventing spread of false information on a platform is disclosed. The method includes maintaining a personally identifiable information and a pseudonymous identity associated with one or more registered users upon registration by the one or more users on the information sharing system. The method also includes capturing the pseudonymous identity of an originator of information. The method also includes capturing the pseudonymous identity of each information upon sharing the information on at least one information sharing system. The method also includes recording reported false information without knowing information about the pseudonymous identity of the originator of information. The method also includes verifying claim associated with a reported false information without the knowledge of originator or reporter upon receiving confirmation about the message shared on at least one information sharing system. The method also includes storing verified false information of at least one information sharing system, upon confirmation of sharing of the false information on at least one of the information sharing system and confirmation of the falsehood by fact checkers, without knowledge of the originator or reporter of information. The method also includes enabling the information sharing system to take actions such as prevent forwarding, flagging or deleting information against the end users involved in the false information blocklist like based on business requirement without any knowledge of originator of information, reporter, verifier and holder of the false information. The method also includes enabling an entity to request for pseudonymous identity of the originator of the information from the maintainer of pseudonymous identity and shared information mapping subsystem upon digital confirmation of information sharing on the information sharing system, reporting and verification of the information. The method also includes enabling the entity to further request for the personally identifiable information of the acquired pseudonymous identity of the originator.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to find origin and to prevent spread of false information on a platform in accordance with an embodiment of the present disclosure;

FIG. 2 is a block diagram of an embodiment of the system to find origin and to prevent spread of false information on a platform of FIG. 1 in accordance with an embodiment of the present disclosure;

FIG. 3 is a block diagram of a general computer system in accordance with an embodiment of the present disclosure; and

FIG. 4a and FIG. 4b is a flow diagram representing steps involved in a method for finding origin and for preventing spread of false information on a platform in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system to find origin and to prevent spread of false information on a platform. The system includes a user identity mapping subsystem configured to maintain a personally identifiable information and a pseudonymous identity associated with one or more registered users upon registration by the one or more users on the information sharing system. The system also includes a pseudonymous identity and shared information subsystem operatively coupled to the user identity mapping subsystem. The pseudonymous identity and shared information subsystem are configured to capture the pseudonymous identity of an originator of information. The pseudonymous identity and shared information subsystem are also configured to capture the pseudonymous identity of each information upon sharing the information on at least one information sharing system. The system also includes a falsehood reporting subsystem configured to record reported false information without knowing information about the pseudonymous identity of the originator of information. The system also includes a fact checker subsystem operatively coupled to the falsehood reporting subsystem. The fact checker subsystem is configured to verify claim associated with a reported false information without the knowledge of originator or reporter upon receiving confirmation about the message shared on at least one information sharing system. The system also includes a false information blacklist subsystem operatively coupled to the fact checker subsystem. The false information blacklist subsystem is configured to store verified false information of at least one information sharing system, upon confirmation of sharing of the false information on at least one of the information sharing system and confirmation of the falsehood by fact checkers, without knowledge of the originator or reporter of information. The system also includes a false information spread prevention subsystem operatively coupled to the false information blacklist subsystem. The false information spread prevention subsystem is configured to enable the information sharing system to take actions such as prevent forwarding, flagging or deleting information against the end users involved in the false information blocklist like based on business requirement without any knowledge of originator of information, reporter, verifier and holder of the false information. The system also includes an origin identification subsystem operatively coupled to the false information spread prevention subsystem. The origin identification subsystem is configured to enable an entity to request for pseudonymous identity of the originator of the information from the maintainer of pseudonymous identity and shared information mapping subsystem upon digital confirmation of information sharing on the information sharing system, reporting and verification of the information. The origin identification subsystem is also configured to enable the entity to further request for the personally identifiable information of the acquired pseudonymous identity of the originator.

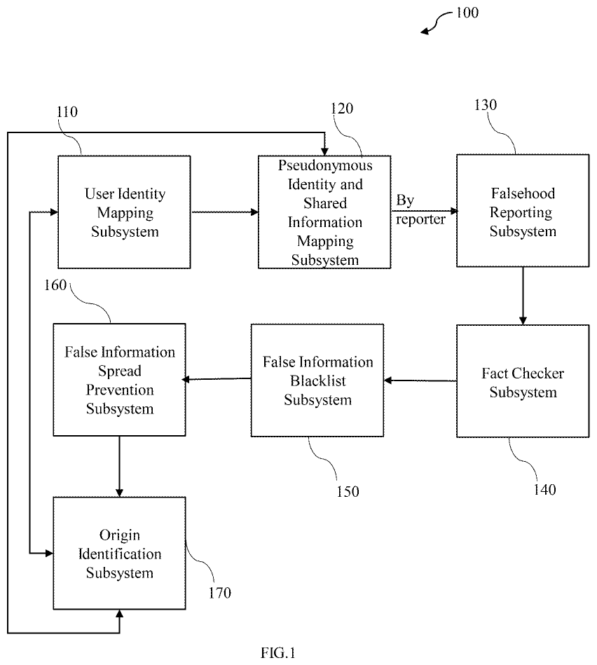

FIG. 1 is a block diagram representation of a system 100 to find origin and to prevent spread of false information on a platform in accordance with an embodiment of the present disclosure. As used herein, information is associated with data and knowledge, as data is meaningful information and represents the values attributed to parameters. Further knowledge signifies understanding of an abstract or concrete concept.

The system 100 includes a user identity mapping subsystem 110 configured to maintain a personally identifiable information and a pseudonymous identity associated with one or more registered users upon registration by one or more users on an information sharing platform. In one embodiment, the information sharing platform may include an end-to-end encrypted messaging platform, social media platform and an internet-based software platform for creating and sharing the information across a plurality of information sharing system in multiple countries or just for a specific country.

In one embodiment, the pseudonymous identity of shared information may include a cryptographic representation of the information, wherein the cryptographic representation of information may include one of a hash of the information which is a natural fingerprint of the information and a pseudo-random number artificially attached to the information and traverses with the information across an ecosystem.

The system 100 also includes a pseudonymous identity and shared information mapping subsystem 120 operatively coupled to the user identity mapping subsystem 110. The pseudonymous identity and shared information subsystem 120 are configured to capture the pseudonymous identity of an originator of information. The pseudonymous identity and shared information subsystem 120 are also configured to capture pseudonymous identity of each information upon sharing the information on at least one information sharing system.

In one specific embodiment, the pseudonymous identity and shared information subsystem 120 may be configured to capture only new and unique information which is validated through cryptographic hash value for identifying the origin of information. In case of restricted data access, there may be a global anonymized list of unique messages sent on the platform. This anonymized list may be populated by user's pseudonymous identity and shared information after anonymization. The access to such anonymized list may be provided just to legally authorized entities only. This may be a confirmatory database to validate uniqueness of the shared information.

The system 100 also includes a falsehood reporting subsystem 130 configured to record reported potential false information without knowing information about the pseudonymous identity of the originator of information, a connection with pseudonymous identity and shared information subsystem is established only in the future, when the reported message is verified as false information and an authorized entity does a comparison to identify the origin. In one embodiment, the false information may include intent and knowledge. In such embodiment, the intent may include misinformation and disinformation. Further, the misinformation may include urban legends. The disinformation may include fake news. The knowledge may include opinion-based knowledge and fact-based knowledge. The opinion-based knowledge may include fake reviews. The fact-based knowledge may include hoaxes.

The system 100 also includes a fact checker subsystem 140 operatively coupled to the falsehood reporting subsystem 130. The fact checker subsystem 140 is configured to verify claim associated with a reported false information without the knowledge of originator or reporter upon receiving confirmation about the message shared on at least one information sharing system. In one embodiment, the fact checker subsystem 140 may be configured to verify the claim associated with the reported false information by generating a poll for receiving opinion from one or more authorized users. In such embodiment, the one or more authorized users may include a plurality of government agencies such as a police, a health care, a cyber security and the like.

In such embodiment, the fact checker subsystem 140 may be configured to receive a voting on a poll from the one or more authorized users till a predefined period. The fact checker subsystem 140 may be configured to generate a score for the one or more authorized users based on weightage of votes for verifying the claim by using a game theory function. As used herein, the term “game theory function” is defined as a study of mathematical models of strategic interaction between rational decision-makers, incentivizing truthful behaviour between participation and active information sharing on verified facts. Decision on a reported fact checking may be achieved in one round of strategic game or an extensive round of games.

In one specific embodiment, the system 100 may include an incentivization subsystem configured to incentivize one or more participants, human or autonomous agents for reporting or validating truth by rewarding and penalizing appropriately till a consensus beyond a predefined cut-off threshold is reached.

The system 100 also includes a false information blacklist subsystem 150 operatively coupled to the fact checker subsystem 140. The false information blacklist subsystem 150 is configured to store verified false information of the at least one information sharing system, upon confirmation of sharing of the false information on the at least one of the information sharing system and confirmation of the falsehood by the fact checkers, without knowledge of the originator or reporter of information.

In one embodiment, one or more user devices may access the false information blacklist, wherein the false information blacklist may include an actual false information enables the one to more users to run model on the one or more user devices to identify and block even variants of verified false information which are slightly modified or translated to avoid detection and blocking upon identifying the changes in content results, wherein the changes in content results may include the hash of the information unmatched with the hash of blacklisted information. By comparing their received information against these verified false information, even modified or translated false information can be identified and necessary action like flagging or deletion or prevention from forwarding or copying can be automated at the device. This will help identify and prevent spread of modified false information.

The system 100 also includes a false information spread prevention subsystem 160 operatively coupled to the false information blacklist subsystem 150. The false information spread prevention subsystem 160 is configured to enable the information sharing system to take actions such as prevent forwarding, flagging or deleting information against the end users involved in the false information blocklist like based on business requirement without any knowledge of originator of information, reporter, verifier and holder of the false information. This may be automated by implementing the logic at the client system. In case of using Blockchain based solutions, these functionalities may be automated by using the likes of Smart contract.

In one embodiment, the prevention of spread of false information is achieved through a Zero Knowledge Proof based framework complying with requirements of completeness, soundness and zero leak of knowledge, wherein the information sharing system does not know information about the originator, reporter, verifier, information holder or platform of origin but convinced with the fact that the shared information is false and needs to be prevented from spreading.

As used herein, the zero-knowledge proof technique helps in automating the process of prevention of spreading the false information. The zero-knowledge proof technique meets a plurality of conditions of the system being zero knowledge, wherein the plurality of conditions includes:
a. Completeness: if the statement is true, information sharing platform (verifier) will be convinced of the fact by the fact checkers (honest prover).
   The fact checkers (honest prover) will be able to convince that:
      1. The false information was shared on the information sharing platform.
      2. The false information was reported by a user registered on an information sharing system.
      3. The information was validated, found false and digitally signed by the fact checkers.
      4. The fact checkers are the validator of the false information.
b. Soundness: if the statement is false, no fact checker (cheating prover) can convince the information sharing system (honest verifier) that the false information on the information sharing system is true.
   No fact checker (cheating prover) can convince
      1. If the verified false information was never shared on a participating information sharing system, fact checker can't report the pseudonymous identity of information: as information hash database check will fail.
      2. If the information was never reported on the information sharing system, no report would be found in the reported false information database and hence a database check will fail.
      3. If not digitally signed by the fact checkers, then verification at the information sharing system would fail.
c. Zero Knowledge: If the statement is true (verified false information shared on the information sharing system), no verifier (information sharing system) learns anything other than the fact that the statement is true.
   The information sharing system gets no information other than verification by the fact checkers and that the information was shared and reported on a specific information sharing system.
      1. The information sharing system does not know the personally identifiable information of the reporter as pseudonymous identity of reporter is never shared with or can be accessed on information sharing system.
      2. The information sharing system does not know the personally identifiable information of the information originator or forwarder of the information.
      3. The information sharing system does not know any information about other information of the reporter or the information originator or receiver.

The system 100 also includes an origin identification subsystem 170 operatively coupled to the false information spread prevention subsystem 160. The origin identification subsystem 170 is configured to enable a legally authorized entity to request for pseudonymous identity of the originator of the information from the maintainer of pseudonymous identity and shared information mapping subsystem upon digital confirmation of information sharing on the information sharing system, reporting and verification of the information. In one embodiment, the entity may include a judiciary system. The origin identification subsystem 170 is also configured to enable the entity to further request for the personally identifiable information of the acquired pseudonymous identity of the originator.

In one embodiment, the origin of false information is identified through a Zero Knowledge Proof based framework complying with requirements of completeness, soundness and Zero leak of knowledge, therefore no participant except judiciary after a certain stage of trial get to know about the identity of the originator, pseudoidentity of the originator, reporter of the false information, receivers of the false information or forwarders of the false information, as only judiciary requests for and acquire pseudo identity and original identity of the originator by sharing convincing information sharing system with all of the digital proofs such as the false information originated on platform, reported and verified as false, the pseudonymous identity is claimed and there is a prima facie charge against the originator.

The zero-knowledge proof technique meets plurality of conditions of the system being Zero knowledge, wherein the plurality of conditions includes:
a. Completeness: if the statement is true, the information sharing system (honest verifier) will be convinced of this fact by the judiciary, law enforcement and fact checkers (honest prover).
   An honest information sharing system will be convinced of the fact that the submitted pseudonymous identity is the originator of claimed false information only if it is true as:
      1. Fact verification with proof of truth submitted and digitally signed by the fact checkers matches in the database.
      2. Request for the personally identifiable information by judiciary after convincing argument that identity of originator is required, digitally signed by judiciary matches in the database.
      3. Valid pseudonymous identity and transaction id of fetching pseudonymous identity presented by judiciary matches in the database.
b. Soundness: if the statement is false, no cheating prover (judiciary or Fact Checker or regulator) can convince the honest verifier (information sharing system) that it is true (allow message to stay on platform).
   No Cheating prover—judiciary or fact checker or hacker or regulator can convince information sharing system to provide personally identifiable information of the information originator as:
      1. If anybody other than judiciary is trying to get the personally identifiable information of the information originator, the it's not possible as the personally identifiable information is sent only to judiciary. Else verification by the information sharing system will fail.
      2. The judiciary alone can't fake as the fact checkers should have confirmed the false information and there should be a case open—digitally signed by fact checkers and plaintiff. Else verification by information sharing system will fail.
      3. Law Enforcement agency alone can't fake as digital signatures of the fact checkers and judiciary will be required. Else verification by information sharing system will fail.
      4. The regulator or auditor maintaining the database can't fake, as they can't generate any of the digital assets required for ID request. Any change to asset can also be easily tracked. Can't even request for Identity.
      5. The hacker with identity of any one of the identity can't do much as digital consent of other participants are required. Hence verification by information sharing system will fail.
      6. The only remote possibility is that of everyone including the fact checkers, law enforcement, judiciary, regulator and auditor colluding. Even in that case the accused can fight his case in the court. When the solution is implemented on an immutable ledger even this remote possibility is prevented.
c. Zero-knowledge: if the statement is true (information is false), no verifier (end to end encrypted messaging platform) learns anything other than the fact that the statement is true (learns no detail about the content of the information sent by this user or users who forwarded this information or who reported this information as false.
   The information sharing system or fact checker or law enforcement or judiciary is not leaked any information other than the fact that:
      1. A reported information is false and the originator's personally identifiable information is revealed to judiciary based on their proven request.
   Some example of information not leaked to anyone in the ecosystem including the information sharing system, regulator and judiciary are:
      1. Content about any information other than the reported information.
      2. Information about the destination or forwarders of the information.
      3. Information about reporters of the message.
      4. Information about other messages sent by the accused originator.
      5. Information sent to the accused originator by others.
      6. Pseudonymous Identity of the false information originator is only shared by information sharing system to judiciary and is not leaked to anyone else in the ecosystem.

In one embodiment, the origin and prevention of spread of false information may be implemented on a database, wherein the database may be one or a combination of centralized, cloud-based hybrid database or a Distributed Ledger Technology. A Distributed Ledger Technologies based database improves the ability to convince much faster in a Zero Knowledge Proof system of origin and prevention of spread of false information.

In one specific embodiment, user identity mapping subsystem 110 is private to user platforms, pseudonymous identity and shared information mapping subsystem 120 is restricted to individual users for creation and read operations and regulator for hash matching, falsehood reporting subsystem 130 is private to fact checkers, fact checker subsystem 140 is private to fact checkers, false information blacklist subsystem 150 is open to all users, false spread prevention subsystem 160 is embedded into user devices to monitor any blacklisted information locally on the user device without connecting outside and an origin identification subsystem 170 is private to the entity and law enforcement agencies.

As used herein, the term “regulator” is defined as a consortium of users or consortium of participant platforms or public authority or government agency or any legally authorized entity responsible for exercising autonomous and neutrally governed authority over some area of human activity in a regulatory or supervisory capacity maintaining data privacy.

In such embodiment, the system 100 may include a fake blocker subsystem operatively coupled to the origin identification subsystem 170. The fake blocker subsystem may be configured to take a plurality of actions by the judiciary against the false information originator upon receiving the personally identifiable information of the acquired pseudonymous identity of the originator. In one embodiment, the plurality of actions may include preventing originator from sending any information for next few months, preventing the originator from forwarding any information, banning the originator from the platform or any judicial penalty and the like.

In the present context of the invention, each subsystem can be owned and managed by different stake holders. To get the personally identifiable information of the originator of a false information, the hash of the false information should have been present in pseudonymous identity and shared information subsystem 120 proving sharing of message in the information sharing platform, should have been reported as false information in a falsehood reporting subsystem 130, should have been verified as false information in a fact checker subsystem 140, should have been part of a false information blacklist subsystem 150, should have the possession of originator pseudo identity through origin identification subsystem 170 and should be an approved authority to get access to the identity of the originator. During each of the abovementioned stages, completion of the previous stage and executioner of the current stage are to be cryptographically verified for identity and authorization for performing the current action

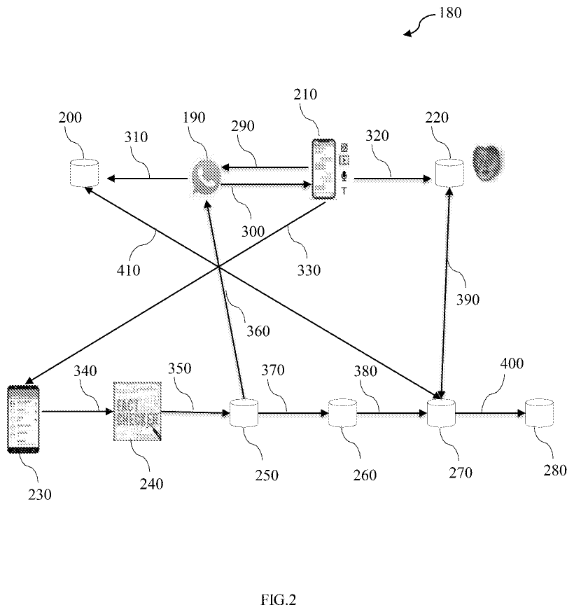

FIG. 2 is a block diagram of an embodiment of the system 180 to find origin of information and prevention of spread of verified fake information on an information sharing system of FIG. 1 in accordance with an embodiment of the present disclosure. A user X registers on an ABC platform 190 by providing personal details 290 such as a mobile number and a username. The ABC platform 190 sends a onetime password to a user device for confirming the mobile number. Upon confirming the mobile number, a pseudo identification number 300 is provided to the user X. Simultaneously, a user identity mapping subsystem 110 maintains the personal details 290 and a pseudo identification number 300 in a database 200 with access only for the ABC platform 190 corresponding to the personal details 290 provided by the user X during registration.

Upon maintaining the personal details 290 and pseudo identification number 300, the user X starts communicating with a user Y by sending a message through the ABC platform 170. Upon sending the message to the user Y, identity of message is represented through hash 330. The identity of each message and pseudonymous identity of message originator is captured by the pseudonymous identity and shared information subsystem 120 in a pseudonymous mapping database for message and origin identity 220. Upon receiving the message by user Y on XYZ platform 230, if the user Y finds received message as a false message then the user Y reports about the false message by a falsehood reporting subsystem 130 to fact checkers without knowing information about the pseudonymous identity of the message originator in flow 340. The fact checker 240 checks the reported message by validating corresponding facts through their research. Further, if there is a need for voting and consensus and information sharing among fact checkers, it has to be done, for achieving consensus.

Upon checking the reported message, the fact checker subsystem 140 provides the false message verification result with proof of truth in flow 350. Once the message is verified, the message is listed by the fact checker or judiciary or law enforcement agency 250 in a false information blacklist subsystem 150 which is picked up by all participating social media and messaging platforms in flow 360.

Consequently, a plaintiff or a law enforcement agency files a case 260 against the fake message and demands in a judiciary system to identify an originator of the false message in flow 370. This filing happens on the origin identification subsystem 170 with a digital proof. Upon digital confirmation of information sharing on the information sharing system, reporting and verification of the information in flow 380, the judiciary first query in pseudonymous mapping database for message and origin identity 220 for pseudonymous identity of the message originator from the maintainer of pseudonymous identity and shared information mapping subsystem in flow 390. Upon receiving the pseudonymous identity of message originator, the judiciary further request for the personal details of the originator in flow 410. Upon receiving the personal details, judiciary prevents the user X from sending any message for next few months, prevents user X from forwarding any message, reduces the life span of user's message or bans the user X from the network in flow 400 or any penalty as per the law.

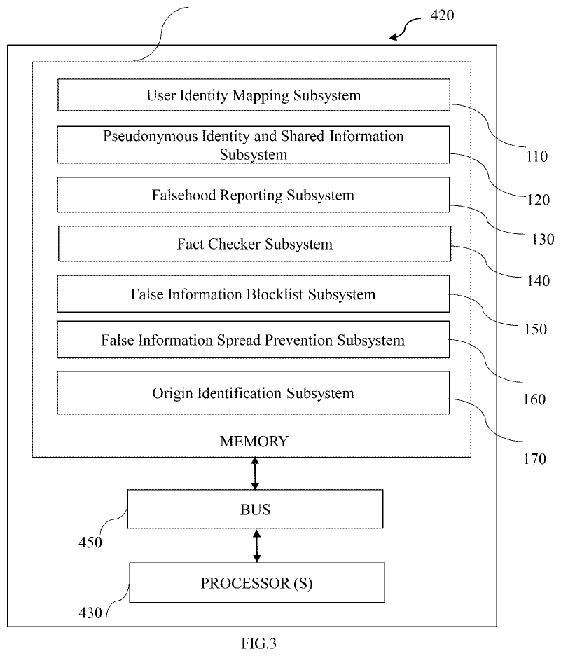

FIG. 3 is a block diagram of a general computer system 420 in accordance with an embodiment of the present disclosure. The computer system 420 includes processors 430, and memory 440 coupled to the processors 430 via a bus 450.

The processors 430, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 440 includes a plurality of subsystems stored in the form of executable program which instructs the processor 430 to perform the configuration of the system illustrated in FIG. 1. The memory 440 has following subsystems: a user identity mapping subsystem 110, a pseudonymous identity and information sharing mapping subsystem 120, a falsehood reporting subsystem 130, a fact checker subsystem 140, a false information blacklist subsystem 150, a false spread prevention subsystem 160 and an origin identification subsystem 170 of FIG. 1.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program subsystems, including functions, procedures, data structures, and application programs, for performing tasks, or defining abstract data types or low-level hardware contexts. Executable program stored on any of the above-mentioned storage media may be executable by the processor(s) 430.

The user identity mapping subsystem 110 instructs the processor(s) 430 to maintain a personally identifiable information and a pseudonymous identity associated with one or more registered users upon registration by the one or more users on the information sharing system.

The pseudonymous identity and information sharing mapping subsystem 120 instructs the processor(s) 430 to store capture the pseudonymous identity of an originator of information.

The pseudonymous identity and information sharing mapping subsystem 120 instructs the processor(s) 430 to capture the pseudonymous identity of each information upon sharing the information on at least one information sharing system.

The falsehood reporting subsystem 130 instructs the processors 430 to record reported false information without knowing information about the pseudonymous identity of the originator of information.

The fact checker subsystem 140 instructs the processors 430 to verify claim associated with a reported false information without the knowledge of originator or reporter upon receiving confirmation about the message shared on at least one information sharing system.

The false information blacklist subsystem 150 instructs the processors 430 to store verified false information of at least one information sharing system, upon confirmation of sharing of the false information on at least one of the information sharing system and confirmation of the falsehood by fact checkers, without knowledge of the originator or reporter of information.

The false spread prevention subsystem 160 instructs the processors 430 to enable the information sharing platform to take actions such as prevent forwarding, flagging or deleting information against the end users involved in the false information blacklist like based on business requirement without any knowledge of originator of information, reporter, verifier and holder of the false information.

The origin identification subsystem 170 instructs the processors 430 to enable an entity to request for pseudonymous identity of the originator of the information from the maintainer of pseudonymous identity and shared information mapping subsystem upon digital confirmation of information sharing on the information sharing system, reporting and verification of the information.

The origin identification subsystem 170 instructs the processors 430 to enable the entity to further request for the personally identifiable information of the acquired pseudonymous identity of the originator.

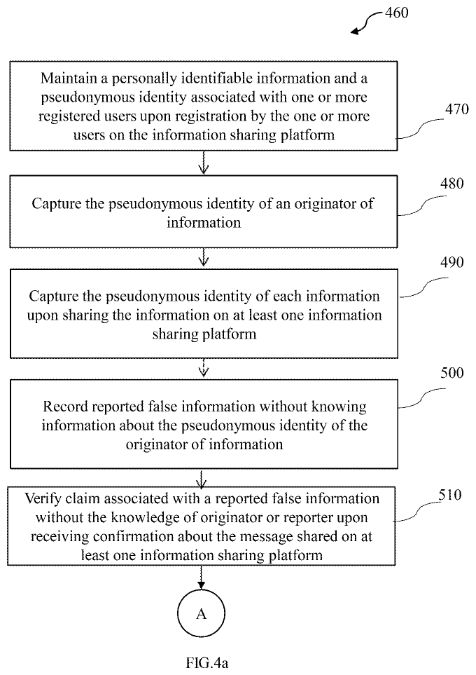

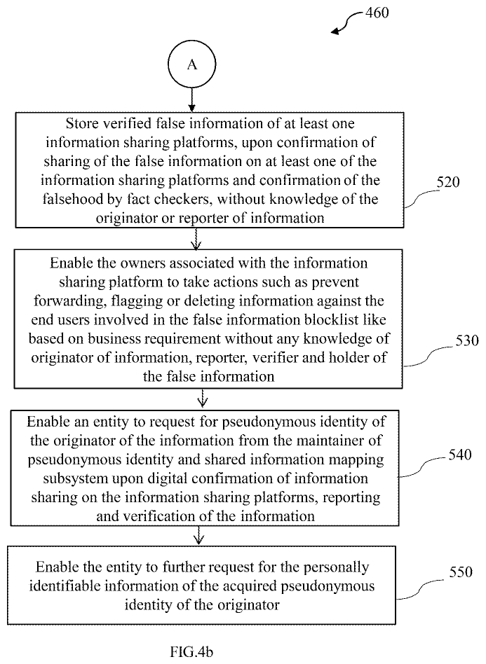

FIG. 4 is a flow diagram representing steps involved in a method 460 for finding origin and preventing spread of false information on a platform in accordance with an embodiment of the present disclosure.

The method 460 includes maintaining, by a user identity mapping subsystem, a personally identifiable information and a pseudonymous identity associated with one or more registered users upon registration by one or more users on an information sharing system in step 470. In one embodiment, maintaining the pseudonymous identity of shared information may include maintaining a cryptographic representation of the shared information, wherein the cryptographic representation of information comprises a one of a a cryptographic hash of the information which is a natural fingerprint of the information, a pseudo-random number artificially attached to the information and traverses with the information across an ecosystem.

The method 460 also includes capturing, by a pseudonymous identity and shared information mapping subsystem, the pseudonymous identity of an originator of information in step 480. The method 460 also includes capturing, by the pseudonymous identity and shared information subsystem, pseudonymous identity of each information upon sharing the information on at least one information sharing system in step 490.

In one specific embodiment, capturing the pseudonymous identity of each information may include capturing only new and unique information which is validated through cryptographic hash value for identifying the origin of information, along with the time of first sharing of the false information in any of the participant platforms.

The method 460 also includes recording, by a falsehood reporting subsystem, reported false information without knowing information about the pseudonymous identity of the originator of information in step 500.

The method 460 also includes verifying, by a fact checker subsystem, claim associated with a reported false information without the knowledge of originator or reporter upon receiving confirmation about the message shared on at least one information sharing system in step 510. In one embodiment, verifying the claim associated with the reported false information may include verifying the claim associated with the reported false information by generating a poll for receiving opinion from one or more authorized users. In such embodiment, generating the poll for receiving opinion from the one or more authorized users may include generating the poll for receiving opinion from a plurality of government agencies such as a police, a health care, a cyber security and the like.

In such embodiment, the method 460 may include receiving a voting on the poll from the one or more authorized users till a predefined period. The method 460 may also include generating a score for the one or more authorized users based on weightage of votes for verifying the claim by using a game theory function.

In one specific embodiment, the method 460 may also include incentivizing, by an incentivization subsystem, one or more participants, human or autonomous agents for reporting or validating truth by rewarding and penalizing appropriately till a consensus beyond a predefined cut-off threshold is reached.

The method 460 also includes storing, by a false information blacklist subsystem, verified false information of the at least one information sharing system, upon confirmation of sharing of the false information on the at least one of the information sharing system and confirmation of the falsehood by the fact checkers, without knowledge of the originator or reporter of information in step 520.

In one embodiment, the method 460 may include accessing the false information blacklist by one or more user devices wherein the false information blacklist may include an actual false information enables the one to more users to run model information which are slightly modified or translated to avoid detection and blocking upon identifying the changes in content results, wherein the changes in content results may include the hash of the information unmatched with the hash of block listed information.

The method 460 also includes enabling, by a false information spread prevention subsystem, the information sharing system to take actions such as prevent forwarding, flagging or deleting information against the end users involved in the false information blocklist like based on business requirement without any knowledge of originator of information, reporter, verifier and holder of the false information in step 530.

In one embodiment, the method 460 may include preventing spread of false information through a Zero Knowledge Proof based framework complying with requirements of completeness, soundness and zero leak of knowledge, wherein the information sharing system does not know information about the originator, reporter, verifier, information holder or platform of origin but convinced with the fact that the shared information is false and needs to be prevented from spreading.

The method 460 also includes enabling, by an origin identification subsystem, an entity to request for pseudonymous identity of the originator of the information from the maintainer of pseudonymous identity and shared information mapping subsystem upon digital confirmation of information sharing on the information sharing system, reporting and verification of the information in step 540. In one embodiment, enabling the entity to request for pseudonymous identity of the originator of the information may include enabling a judiciary to request for pseudonymous identity of the originator of the information. The method 450 also includes enabling, by the origin identification subsystem, the entity to further request for the personally identifiable information of the acquired pseudonymous identity of the originator in step 550.

In one embodiment, the method 460 may include identifying the origin of false information through a Zero Knowledge Proof based framework complying with requirements of completeness, soundness and Zero leak of knowledge, therefore no participant except judiciary after a certain stage of trial get to know about the identity of the originator, pseudoidentity of the originator, reporter of the false information, receivers of the false information or forwarders of the false information, as only judiciary requests for and acquire pseudo identity and original identity of the originator by sharing convincing information sharing system with all of the digital proofs such as the false information originated on platform, reported and verified as false, the pseudonymous identity is claimed and there is a prima facie charge against the originator.

In one embodiment, the method 460 may include implementing the origin and prevention of spread of false information on a database. In such embodiment, implementing the origin and prevention of spread of false information on the database may include implementing the origin and prevention of spread of false information on one of a distributed ledger, a blockchain, an auditable ledger and an immutable ledger for improving the trust of digital data shared, the ability to convince much faster and automate transactions with smart contract.

In such embodiment, the method 460 may include taking, by a fake blocker subsystem, a plurality of actions by the judiciary against the false information originator upon receiving the personally identifiable information of the acquired pseudonymous identity of the originator. In one embodiment, taking the plurality of actions may include preventing originator from sending any information for next few months, preventing the originator from forwarding any information, banning the originator from the platform or any judicial penalty and the like.

Various embodiments of the origin finding system enable the system to track the incorrect information originator by identifying the phone number, GPS coordinates, Device used, IP address and the likes of Personally identifiable or trackable information of the information originator. The proposed system may also provide security by providing a private immutable database. The proposed system also encourages a plurality of users to participate in determining legitimacy of the incorrect information by offering a plurality of rewards.

Moreover, the system generates a unique code for every unique information which eliminates the redundancy in the database and maintains the integrity of the database. Hence, the system helps in maintaining the privacy of customers, identify origin of incorrect information and prevent spreading of the information which makes such system efficient and reliable. It also helps information sharing system comply with national integrity and security regulations of countries. Such system identifies the origin of false news and discourages miscreants from spreading false news in the information sharing system.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system to find origin and prevent spread of false information across information sharing platforms comprising:
a user identity mapping subsystem, configured in a computing system operable by a processor, is configured to maintain a personally identifiable information and a pseudonymous identity associated with registered users upon registration by corresponding information sharing platforms;
a pseudonymous identity and shared information subsystem, configured in a computing system operable by the processor, operatively coupled to the user identity mapping subsystem, and configured to:
capture the pseudonymous identity of an originator of an information in the information sharing platform;
capture the pseudonymous identity of each information upon sharing the information on an information sharing platform,
wherein each capture contains the pseudonymous identity of the information originator and the pseudonymous identity of the new and unique information being shared along with the time stamp of the sharing, of which uniqueness of the shared information is confirmed by validating with this subsystem;
a falsehood reporting subsystem, configured in a computing system operable by the processor, operatively coupled to the pseudonymous identity and shared information subsystem and configured to record reported false information by a reporter without knowing information about the pseudonymous identity of the originator of information shared across the one or more information sharing platforms;
a fact checker subsystem, configured in a computing system operable by the computer processor, operatively coupled to the falsehood reporting subsystem, and configured to receive verification associated with a reported false information by single or multiple fact-checkers without knowledge of originator or reporter upon receiving confirmation that the message was shared within information sharing platforms;
a false information blacklist subsystem, configured in a computing system operable by the computer processor, operatively coupled to the fact checker subsystem, and configured to blacklist and store verified false information,
wherein the verified and confirmed false information and their cryptographic hashes are stored and made available to all subscribing information sharing platforms;
a false information spread prevention subsystem, configured in a computing system operable by the computer processor, operatively coupled to the false information blacklist subsystem, and configured to enable the information sharing platform to take actions of prevent forwarding, flagging or deleting blacklisted information without any knowledge of originator of information, reporter, verifier and holder of the false information;
an origin identification subsystem, configured in a computing system operable by the computer processor, configured to
enable an authorized entity to request for pseudonymous identity of the originator of the information from the maintainer of pseudonymous identity and shared information mapping subsystem upon digital confirmation of information sharing on the information sharing platform, reporting and verification of the information; and
enable the entity to request next for the personally identifiable information of the acquired pseudonymous identity of the originator from the user identity mapping subsystem of the originator platform.

2. The system as claimed in claim 1, wherein the information sharing platform comprises an end-to-end encrypted messaging platform, social media platform and an internet-based information sharing platforms for creating and sharing the information across a plurality of information sharing system across a plurality of countries.

3. The system as claimed in claim 1, wherein the pseudonymous identity of the shared information comprises a representation of the information stored with pseudonymous identity and shared information subsystem, wherein the representation of information include one of a hash of the information which is a natural fingerprint of the information and a pseudonymous representation which in addition to storage in subsystem is also artificially attached to the information and traverses with the information across information sharing platforms.

4. The system as claimed in claim 1, wherein the user devices are communicatively coupled to the information sharing platform and enabled to access the false information blacklist and compare messages they have received against hashes of verified false messages, and
take the actions, once matches are found, prevent forwarding, flagging or deleting blacklisted information, thereby identify and prevent spread of unaltered verified false information.

5. The system as claimed in claim 1, wherein the false information blacklist subsystem being configured to enable the users to run model on the user devices to identify and block even variants of verified false information which are slightly modified or translated to avoid detection and blocking upon identifying the changes in content results.

6. The system as claimed in claim 1, wherein the prevention of spread of false information is achieved through a Zero Knowledge Proof based framework complying with requirements of completeness, soundness and zero leak of knowledge, wherein the information sharing platform does not know information about the originator, reporter, verifier, information holder or platform of origin but convinced with the fact that the shared information is false and needs to be prevented from spreading.

7. The system as claimed in claim 1, wherein the origin of false information is identified through a Zero Knowledge Proof based framework complying with requirements of completeness, soundness and Zero leak of knowledge, where in the information sharing platform is convinced that the pseudo identity shared is the originator of the verified false information on its platform without learning anything more even in an end-to-end encrypted information sharing platform. After getting convinced about the pseudo identity of originator, personally identifiable identity is fetched.

8. The system as claimed in claim 1, wherein the origin and prevention of spread of false information is implemented on a database with user identification, authorization and auditing, wherein the database comprises one of a distributed ledger, a blockchain, an auditable ledger and an immutable ledger for improving the trust of digital data shared, the ability to convince much faster and automate transactions with smart contract.

9. The system as claimed in claim 1, where in each of the user identity mapping subsystem, the pseudonymous identity and shared information subsystem, the falsehood reporting subsystem, the fact checker subsystem, the false information blacklist subsystem, the false information spread prevention subsystem, the origin identification subsystem being accessed and managed by different participants.

10. The system as claimed in claim 1, comprising an incentivization subsystem configured to incentivize participants, human or autonomous agents for reporting false information from any information sharing platform or validating reported false information from any information sharing platform by rewarding and penalizing appropriately till a consensus beyond a predefined cut-off threshold is reached and the consensus is updated to the fact checker subsystem.

11. A method for finding origin and preventing spread of false information in an information sharing platform comprising:
maintaining, by a user identity mapping subsystem operable by a computer processor, a personally identifiable information and a pseudonymous identity associated with registered users upon registration by the users on the information sharing system;
capturing, by pseudonymous identity and shared information subsystem operable by the computer processor, the pseudonymous identity of an originator of information, wherein the pseudonymous identity of an originator being captured only for new and unique information which is validated through cryptographic hash value for identifying the origin of information;
capturing, by pseudonymous identity and shared information subsystem operable by the computer processor, the pseudonymous identity of each information upon sending the information on participating information sharing platform, wherein the pseudonymous identity of the each information being captured only for new and unique information which is validated through cryptographic hash value for identifying the origin of information, along with the time stamp of the sharing;
recording, by falsehood reporting subsystem operable by the computer processor, a reported false information by a reporter without knowing information about the pseudonymous identity of the originator of information or reporter of false information;
receiving verification, by fact checker subsystem operable by the computer processor, for a claim associated with a reported false information without the knowledge of originator or reporter;
storing, by false information blacklist subsystem operable by the computer processor, verified false information and sharing the blacklist with all participating information sharing platforms, without knowledge of the originator or reporter of information,
wherein originator of the verified false information being identified and blacklisted based on comparing one of a hash of the information which is a natural fingerprint of the information and a pseudo-random number artificially attached to the information;
enabling, by false spread prevention subsystem operable by the computer processor, the information sharing system to take actions such as prevent forwarding, flagging or deleting information against the end users involved in the false information blocklist like based on business requirement without any knowledge of originator of information, reporter, verifier and holder of the false information;
enabling, by origin identification subsystem operable by the computer processor, an entity to request for pseudonymous identity of the originator of the information from maintainer of pseudonymous identity and shared information mapping subsystem upon digital confirmation of information sharing on the information sharing system, reporting and verification of the information; and
enabling, by origin identification subsystem operable by the computer processor, the entity to request next for the personally identifiable information of the acquired pseudonymous identity of the originator.

12. The method as claimed in claim 11, wherein maintaining the pseudonymous identity of shared information comprises maintaining a cryptographic hash of the information, wherein the cryptographic hash of information comprises a natural fingerprint of the information, a pseudo-random number artificially attached to the information and traverses with the information across an ecosystem.

13. The method as claimed in claim 11, wherein preventing the spread of false information comprises preventing spread of false information through a Zero Knowledge Proof based framework complying with requirements of completeness, soundness and zero leak of knowledge, wherein the information sharing system does not know information about the originator, reporter, verifier, information holder or platform of origin but convinced with the fact that the shared information is false and needs to be prevented from spreading, wherein preventing the spread of false information comprises
comparing message received at the user devices against hashes of verified false information stored in the false information blacklist, where the user devices are communicatively coupled to the information sharing platform and enabled to access the false information blacklist, and
taking the actions of prevent forwarding, flagging or deleting blacklisted information, once matches are found upon comparing messages, thereby identifying and preventing spread of unaltered verified false information.

14. The method as claimed in claim 11, identifying origin of false information comprises identifying origin of the false information through a Zero Knowledge Proof based framework complying with requirements of completeness, soundness and Zero leak of knowledge,
wherein identifying the origin of the false information through a Zero Knowledge Proof based framework comprises
fetching personally identifiable identity after getting convinced about the pseudo identity of originator,
wherein the fetching of the personally identifiable identity being based on predefined sequence of conditions comprising
the hash of the false information should have been present in pseudonymous identity and shared information subsystem proving sharing of message in the information sharing platform,
the information should have been reported as false information in a falsehood reporting subsystem,
the information should have been verified as false information in a fact checker subsystem,
the information should have been part of a false information blacklist subsystem and shared to information sharing platforms,
the information should have the possession of originator pseudo identity through origin identification subsystem and
the entity should be an approved authority to get access to the identity of the originator,
wherein during each of the predefined sequence of conditions, completion of the previous stage and executioner of the current stage are cryptographically verified for identity and authorization for requesting the personally identifiable information across platforms or geographies.

15. The method as claimed in claim 11, the method comprises incentivizing participants, by incentivization subsystem, human or autonomous agents, for reporting or validating truth by rewarding and penalizing appropriately till a consensus beyond a predefined cut-off threshold is reached and the consensus is updated to the a fact checker subsystem.
